(19) United States
(12) Patent Application Publication
(10) Pub. No.: US 2020/0149484 A1
(43) Pub. Date: May 14, 2020

(54) VEHICLE STOP PREDICTION

(71) Applicant: GM GLOBAL TECHNOLOGY OPERATIONS LLC, DETROIT, MI (US)

(72) Inventors: Jianyang Geng, South Lyon, MI (US); Weiyu Wang, Novi, MI (US); Scott R. Jeffrey, Hartland, MI (US)

(21) Appl. No.: 16/185,533

(22) Filed: Nov. 9, 2018

(51) Int. Cl. F02D 41/00; F02M 25/08

(52) U.S. Cl. CPC F02D 41/0032; F02M 25/0854; F02D 2200/101; F02D 2200/602; F02D 2200/501

(57) ABSTRACT

Methods and systems for predicting a vehicle stop event and/or operating a purge pump for a vehicle are disclosed. An example method includes providing a fuel vapor canister in fluid communication with a fuel tank of the vehicle, the fuel vapor canister configured to absorb fuel vapors from the fuel tank, and placing a purge pump in fluid communication with the fuel vapor canister, with the purge pump being configured to pump an external airflow into the canister. Some methods and systems may be directed to predicting a vehicle stop while the vehicle is moving based upon at least a model of vehicle speed, and initiating a vehicle response based upon the prediction. In some examples, a vehicle response includes reducing ambient noise emitted by the purge pump.

### INTRODUCTION

Evaporative emissions canisters are employed in vehicles employing internal combustion engines to reduce emission of fuel vapors from the vehicle. The canisters are typically in fluid communication with a fuel tank, such that fuel vapors emitted from a quantity of hydrocarbon fuel, e.g., gasoline, present in the tank are directed to the canister. Typically, canisters include a vapor-absorbent material within the canister, which retains received vapors. Subsequently, vapors may be released from the canister by circulating a fresh airflow through the canister, thereby drawing the retained vapors out of the canister. The vapor flow may then be directed toward an engine intake.

An intake vacuum may be used to draw fuel vapors out of a canister. In some applications, pumps have been employed to force a fresh airflow through the canister, increasing the degree to which vapors may be expunged from the canister. These purge pumps are particularly useful where intake vacuum of a vehicle engine is unavailable or otherwise insufficient to effectively draw fuel vapors from the canister. However, these pumps create noise that may be audible to vehicle occupants, particularly at low vehicle speeds.

Some vehicle applications have therefore deactivated the purge pumps below a fixed vehicle speed. However, this approach forces a compromise between overall purge capability (and a resulting reduction in overall vehicle evaporative emission performance) and reduction of purge pump noise. More specifically, where the speed threshold is set high enough to adequately reduce pump noise, evaporative emissions performance is negatively affected. Accordingly, there is a need for an improved evaporative emissions system and method of using the same that addresses the above shortcomings.

### SUMMARY

In at least some examples, a method of operating a purge pump for a vehicle includes providing a fuel vapor canister in fluid communication with a fuel tank of the vehicle, the fuel vapor canister configured to absorb fuel vapors from the fuel tank, and placing a purge pump in fluid communication with the fuel vapor canister, with the purge pump being configured to pump an external airflow into the canister. The method may further include predicting a vehicle stop while the vehicle is moving based upon at least a model of vehicle speed, and reducing ambient noise emitted by the purge pump based upon the prediction before the vehicle stops moving.

In some examples, reducing ambient noise emitted by the purge pump includes stopping the purge pump.

In other example approaches, reducing ambient noise emitted by the purge pump includes reducing an activity of the purge pump.

The step of predicting a vehicle stop may, in some examples, include predicting the vehicle stop based upon at least a vehicle speed trend and a driver intention trend. In these examples, the method may further include determining the driver intention trend based upon at least one of a brake pedal position, an accelerator pedal position, and a vehicle deceleration time. In other examples, the method includes determining the driver intention trend based upon at least a brake pedal position, an accelerator pedal position, and a vehicle deceleration time. Still other examples of a method may further include determining the vehicle speed trend based upon at least one of a vehicle speed, a vehicle deceleration, and a rate of change of vehicle engine speed. Other example methods may include determining the vehicle speed trend based upon at least a vehicle speed, a vehicle deceleration, and a rate of change of vehicle engine speed.

In at least some example approaches, a method further includes determining an extended deceleration state of the vehicle based upon at least a vehicle deceleration time. In at least some of these examples, the predicted vehicle stop is predicted based upon at least the determined extended deceleration state of the vehicle.

At least some example methods may also include correlating vehicle stop events in a vehicle test cycle with at least one of a brake pedal position, an accelerator pedal position, and a vehicle deceleration time, with the predicted vehicle stop being based upon the correlation between the vehicle stop events and the at least one of the brake pedal position, the accelerator pedal position, and the vehicle deceleration time.

In some examples, a method may also include correlating vehicle stop events in a vehicle test cycle with at least a brake pedal position, an accelerator pedal position, a vehicle deceleration time, a vehicle speed, a rate of change of vehicle speed, and a rate of change of vehicle engine speed. In such examples, the predicted vehicle stop may be based upon the correlation between the vehicle stop events and the brake pedal position, the accelerator pedal position, the vehicle deceleration time, the vehicle speed, the rate of change of vehicle speed, and the rate of change of vehicle engine speed.

In at least some examples, a method of predicting a vehicle stop while the vehicle is moving includes predicting an intended vehicle stop while the vehicle is moving based upon at least a model of vehicle speed, and initiating a vehicle response based upon the prediction in step (a) before the vehicle stops moving.

In at least some examples of such methods, predicting the intended vehicle stop includes at least determining a vehicle speed trend based upon at least one of a vehicle speed, a vehicle deceleration, and a rate of change of vehicle engine speed, and determining a driver intention trend based upon at least one of a brake pedal position, an accelerator pedal position, and a vehicle deceleration time. In a subset of these examples, a method may also include providing a fuel vapor canister in fluid communication with a fuel tank of the vehicle, the fuel vapor canister configured to absorb fuel vapors from the fuel tank, and placing a purge pump in fluid communication with the fuel vapor canister, the purge pump configured to pump an external airflow into the canister. The vehicle response may, in these examples, include reducing ambient noise emitted by the purge pump.

At least some examples illustrations are directed to an evaporative emissions control system for a vehicle that includes a fuel vapor canister configured to absorb fuel vapors from a fuel tank and a purge pump configured to pump an external airflow into the canister. The system may also include a processor configured to predict a vehicle stop while the vehicle is moving based upon a model of vehicle speed, the processor configured to reduce ambient noise emitted by the purge pump based upon the predicted vehicle stop before the vehicle stops moving.

In at least some examples, the processor is configured to reduce ambient noise emitted by the purge pump by stopping the purge pump.

In other examples, the processor is configured to reduce ambient noise emitted by the purge pump by reducing an activity of the purge pump.

In some example approaches, the processor is configured to determine a vehicle speed trend and a driver intention trend included in the modeled vehicle speed. In at least a subset of these examples, the processor is configured to determine the driver intention trend based upon at least a brake pedal position, an accelerator pedal position, and a vehicle deceleration time, and the processor is configured to determine the vehicle speed trend based upon at least a vehicle speed, a vehicle deceleration, and a rate of change of vehicle engine speed.

### BRIEF DESCRIPTION OF THE DRAWINGS

One or more embodiments of the invention will hereinafter be described in conjunction with the appended drawings, wherein like designations denote like elements, and wherein:

FIG. 1A is a schematic illustration of a vehicle having an evaporative emissions control system, according to one example approach;

FIG. 1B is a schematic illustration of a controller for the evaporative emissions control system of FIG. 1A, according to an example;

FIG. 2A is a schematic illustration of a control methodology for the evaporative emissions control system or vehicle of FIGS. 1A-1B, according to an example;

FIG. 2B is a schematic illustration of another control methodology for the evaporative emissions control system or vehicle of FIGS. 1A-1B, according to an example approach; and

FIG. 3 is a process flow diagram for a method of controlling evaporative emissions in a vehicle, according to one example.

### DETAILED DESCRIPTION

Example illustrations include systems and methods that generally predict an impending vehicle stop event (i.e., the vehicle coming to a complete rest, or substantially so such that ambient noise from operating vehicle components such as the purge pump are audible to vehicle occupants) before it occurs. In this manner, components such as the purge pump may be deactivated or otherwise reduced in activity to reduce noise emitted by the component. Accordingly, the likelihood of vehicle occupants being able to detect operation of the vehicle components, e.g., the purge pump, is reduced or eliminated. The prediction of vehicle stop events based upon multiple factors, as opposed to using a simple speed threshold, results in a robust prediction of vehicle stop events while not compromising purge capability of the evaporative emissions system. Moreover, prediction of intended vehicle stop events (i.e., where the driver is exhibiting an intent to bring the vehicle to a stop or near-zero speed such that the relevant system may be affected or in need of a response relevant to that system) based upon the concepts discussed herein may be applied in non-evaporative emission control contexts. Merely by way of example, prediction of vehicle stop events may be useful in control systems for vehicle transmissions or other components of the vehicle drivetrain.

Vehicle stop events may be predicted based upon previous vehicle testing or real-world data, e.g., emissions test cycles, which may be used to create a virtual model for predicting vehicle stop events. In some examples, a virtual model does not use a direct measurement of vehicle speed as the sole or predominant source of a prediction of a vehicle stop event. The result of the prediction may then be used by a purge pump controller to turn off a purge pump with some lead time for the pump to reduce activity, e.g., by reducing pump speed, prior to an imminent vehicle stop event. Thus, any noise/vibration/harshness (NVH) resulting from the purge pump operation is less detectable by vehicle occupants. The predicted stop event may be used in other aspects of the evaporative emissions system or the vehicle. For example, prediction of vehicle stop events may also be used by a controller of the purge pump to turn off an associated purge valve, thereby synchronizing control of the evaporative canister with that of the purge pump.

By contrast, previous approaches use the vehicle stop events themselves or a simple vehicle speed threshold that is compared with a direct measurement of current vehicle speed to determine when to activate/deactivate the purge pump. These previous approaches force a compromise between overall purge capabilities of the system (which are reduced if the vehicle speed threshold is set relatively high, causing the purge pump to deactivate frequently) and effective reduction of pump noise (which is inadequate if the vehicle speed threshold is set relatively low). Moreover, previous approaches typically suffer from a gap between pump and canister control, e.g., as a result of the vehicle stop event being predicted too early or too late. Accordingly, example approaches described herein may better align control of the canister and the purge pump, in addition to achieving adequate purge capability and less detectable operation of the purge pump.

As mentioned above, example approaches to predicting vehicle stops may be applied in vehicle contexts other an evaporative emissions system. Thus, predictions of a vehicle stop event may be used to implement other vehicle responses. Merely as an example, a predicted vehicle stop may be used to activate or deactivate other noise-emitting vehicle components. Moreover, predictions of vehicle stop events may be useful in other vehicle systems such as a vehicle driveline or transmission systems. More specifically, advance notice of a vehicle stop event may be useful in determining appropriate responses by a vehicle powertrain or other vehicle systems.

### Example System

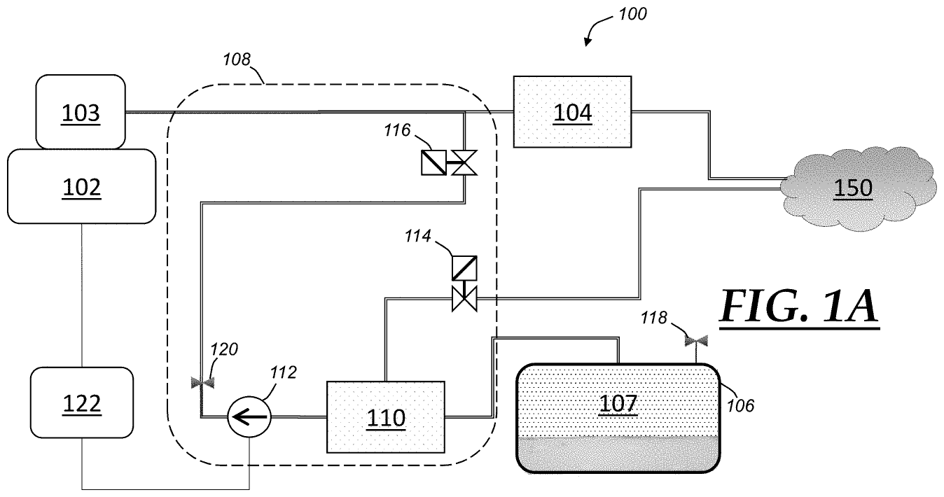

Turning now to FIGS. 1A and 1B, a schematic illustration of an example vehicle 100 having an evaporative emissions control system 108 is illustrated. The vehicle 100 may have an internal combustion engine 102, which draws external or ambient air 150 in via an air filter 104. Fuel may be drawn from the fuel tank 106, e.g., using a fuel delivery system (not shown), e.g., a fuel pump, fuel injectors, etc. Accordingly, fuel is generally mixed with the air, and injected into one or more cylinders of the engine 102 via an intake manifold 103 for combustion. The fuel tank 106 may contain a quantity of liquid hydrocarbon fuel, e.g., gasoline, which is supplied to the intake manifold 103.

The fuel within the tank 106 may generally disperse a fuel vapor 107 within the tank 106, e.g., as a result of the relatively low vapor pressure typical of a gasoline fuel. The vehicle 100 may include an evaporative emissions control system 108, which generally reduces or eliminates evaporative emissions by absorbing some of the dispersed vapor 107, e.g., during refueling of the tank 106. For example, the vapor 107 may be drawn from the fuel tank 106 and into an evaporative canister 110, which contains an absorbent material, e.g., a charcoal material. The absorbent material may absorb at least part of the vapor 107, thereby reducing or preventing loss of the vapor to the external atmosphere or ambient air 150 as the fuel level rises within the tank 106. The vapor 107 may subsequently be expunged from the canister 110 to the intake manifold 103 during vehicle operation, e.g., as discussed below.

While a vacuum or otherwise reduced pressure present in the intake manifold 103 may be effective in some cases to draw fuel vapor out of the canister 110, the evaporative emissions control system 108 illustrated includes a purge pump 112 for increasing effectiveness of scavenging the canister 110 of fuel vapors. For example, the purge pump 112 may be in fluid communication with the canister 110, and when operated may generally draw external air 150 into the canister 110. A solenoid valve 114 between the canister 110 and the ambient air 150 may be opened to allow the ambient or fresh air 150 to flow into the canister 110. The air flows through the canister 110 and to the pump 112, generally drawing vapors stored in the materials within the canister 110 out of the canister 110. The fuel vapors may be directed through another solenoid valve 116, which is opened to allow the entrained vapors 107 to be supplied to the intake manifold 103.

Accordingly, the purge pump 112 may generally facilitate movement of air through the independently of operation of the engine 102 and/or intake manifold 103. The solenoid valves 114, 116 may generally be positioned at an upstream side and a downstream side of the pump 112, respectively, to allow operation and selective bypassing of the pump 112. More specifically, with the upstream solenoid valve 114 closed and the downstream solenoid valve 116 open, the pump 112 may be activated to move purge vapor from the canister 110, through the pump 112, and to the intake manifold 103 to be consumed by the engine 102 during combustion. Alternatively, when the solenoid valve 114 is opened and the pump 112 is deactivated, refilling of the tank 106 is permitted (with vapors becoming entrained in the vapor-absorbent material within the canister 110).

The evaporative emissions control system 108 may also have one or more pressure sensors at various locations to measure internal pressure or pressure caused by the vapor 107. Merely as examples, a tank pressure sensor 118 may be used to determine vapor pressure within the fuel tank 106, while an additional pressure sensor 120 may be positioned downstream of the purge pump 112, thereby permitting monitoring of pressure within the line(s) used to transport vapor toward the intake manifold 103.

One or more controllers 122 may also be provided, either as part of the vehicle 100 or the evaporative emissions control system 108, to implement various methods for controlling evaporative emissions discussed herein. Merely as one example, the controller 122 may be an engine control module (ECM) of the vehicle 100. Accordingly, the controller 122 may generally be in communication with the engine 102, purge pump 112, canister 110, and/or any other components of the vehicle 100 that may be convenient for facilitating control of the evaporative emissions control system 108. The controller 122 may generally include a processor and a computer-readable memory, e.g., a non-transitory computer-readable memory, which include instructions that, when executed by the processor, are configured to monitor and control various aspects of the engine 102, evaporative emissions control system 108, and the vehicle 100 discussed herein.

The controller 122 may be configured to predict a vehicle stop prior to the vehicle stop occurring, and use the predicted vehicle stop to reduce ambient noise emitted by the purge pump before the vehicle stop actually occurs, i.e., before the vehicle 100 stops moving (or, as applied to the purge pump 112, before the vehicle 100 slows sufficiently that operation of the purge pump 112 is detectable audibly or otherwise by vehicle occupants or bystanders). The controller 122 may reduce ambient noise emitted by the purge pump 112 by stopping the purge pump 112 entirely, or by reducing an activity of the purge pump 112 (e.g., reducing an operating speed of the pump 112).

In example illustrations, the controller 122 may predict vehicle stop events based upon a driver intention trend and a vehicle speed trend. These trends may be compared with a history of vehicle usage, e.g., as developed from real-world driving, emissions cycle testing, or other history associated with the vehicle 100. The driver intention trend and vehicle speed trend may be determined based upon any number of vehicle parameters or characteristics monitored by the controller 112 in real-time, as discussed further below. The vehicle parameters or characteristics may include, but are not limited to, one or more of, and in some cases all of, a brake pedal position, an accelerator pedal position, a vehicle deceleration time, a vehicle speed, a rate of change of vehicle speed, and a rate of change of vehicle engine speed. Moreover, as will be discussed below, certain subset(s) of these parameters may be useful in predicting vehicle stop events. In some example approaches, the driver intention trend and the vehicle speed trend are each determined separately, however this is not required.

A driver intention trend, as used herein, generally indicates an intention of a driver of vehicle 100 to stop the vehicle 100. One or more parameters of the vehicle 100 may be monitored in real-time to determine whether the driver intends to stop the vehicle 100. In one example approach, the driver intention trend may generally be determined based upon one or more of a brake pedal position of the vehicle 100, an accelerator pedal position of the vehicle 100, and a deceleration time of the vehicle 100, i.e., an elapsed time associated with a current deceleration of the vehicle. The driver intention trend may be determined using all of the above three parameters in some approaches, or a subset of the three.

A vehicle speed trend, as used herein, may generally provide an indication of a trend in vehicle speed. In some example approaches, the trend of the speed of vehicle 100 may be compared with a history of driving behavior associated with the vehicle 100 or vehicles generally to determine a likelihood of the vehicle 100 coming to a stop. Merely by way of example, by comparing a trend in vehicle speed, deceleration, engine speed, or rates of change associated with vehicle/engine speed with previous trends in the same parameters associated with vehicle stop events, a likelihood that the vehicle 100 is about to stop may be established.

In an example, the controller 122 may determine the vehicle speed trend based upon one or more of a speed of the vehicle 100, a deceleration of the vehicle, and/or a rate of change associated with a speed of the engine 102.

As noted above, a previous history/histories associated with the vehicle 100 may be used to determine whether a vehicle stop event is about to occur. For example, the controller 122 may have a history associated with one or more vehicle parameters, and use a correlation of the same parameters in real-time with the stored history to determine whether a vehicle stop is about to occur. The history may be developed from a test cycle associated with the vehicle 100, or may be learned over time by the controller 122 during vehicle operation. The monitored parameters used in the correlation may include one or more of the parameters mentioned herein. In one example, the parameters include each of a brake pedal position, an accelerator pedal position, and a vehicle deceleration time. In another example approach, the parameters may include a brake pedal position, an accelerator pedal position, a vehicle deceleration time, a vehicle speed, a rate of change of vehicle speed, and a rate of change of vehicle engine speed. Thus, the vehicle stop prediction may be based at least in part upon the correlation between the vehicle stop events and the parameter(s).

Turning now to FIG. 1B, an example controller 122 is described in further detail. Generally, the controller 122 may include one or more sub-controllers configured to provide various functions described herein. However, in other examples a single controller may be used, or embedded in other vehicle controllers such as an engine or powertrain control module, or the like.

The example controller 122, as shown in FIG. 1B, may include a vehicle stop predictor 200, which communicates with an evaporative emissions system controller 202 and a purge pump controller 204. Generally, the vehicle stop predictor 200 may predict vehicle stop events associated with the vehicle 100, using any method or approach that is convenient, as discussed further below. Output(s) of the vehicle stop predictor 200 may be used by the controller 122 to control operation of the purge pump 112, the canister 110, or any other aspects of the vehicle 100. The evaporative emissions system controller 202 may generally receive input(s) from the vehicle stop predictor 200, as may be useful for controlling various aspects of the evaporative emissions system 108. Merely as examples, the evaporative emissions controller 202 may be in communication with the valves 114, 116 and may thereby open/close the valves, or may control other aspects of the operation of the canister 110. The purge pump controller 204 may be in communication with the purge pump 112, and may turn the purge pump 112 on/off, adjust pump speed, etc. Output of the vehicle stop predictor 200 may be used by both the purge pump controller 204 and/or the evaporative emissions controller 202. For example, the vehicle stop predictor 200 may output an idle determination flag in a closed loop control, which may be used by both the purge pump controller 204 and evaporative emissions controller 202 to determine enablement or operation of the purge pump 112 and canister 110, respectively.

### Example Vehicle Stop Probability Models

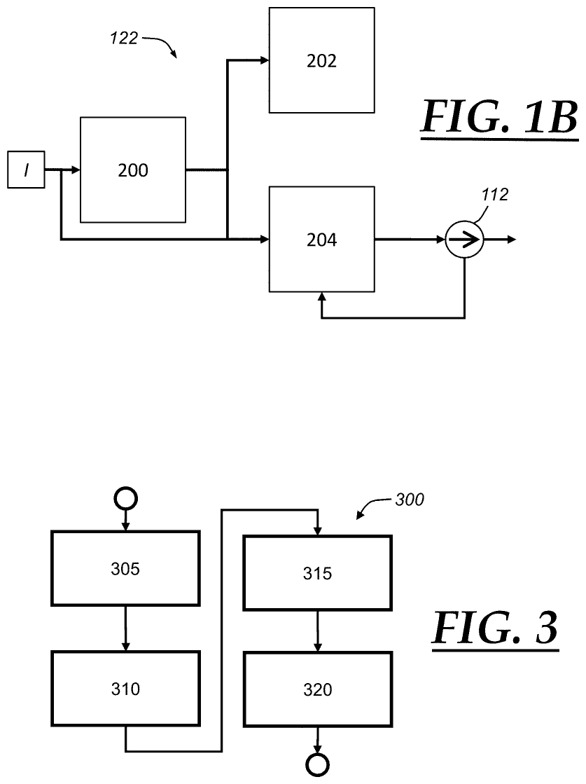

The vehicle stop predictor 200 of the controller 122 may use any approach that is convenient for predicting a vehicle stop event. In a first example illustrated in FIG. 2A, a vehicle stop predictor 200a includes a driver intent determination 206, a vehicle speed trend determination 208, and a vehicle deceleration determination 210. Each of these three sub-controllers or components of the vehicle stop predictor 200a may receive one or more inputs I in real-time, which are directed to various aspects of the vehicle 100 that may be convenient for determining whether/when a vehicle stop event is about to occur. The driver intent determination 206, vehicle speed trend determination 208, and vehicle deceleration determination 210 generally are used by a vehicle stop probability Figure of Merit (FOM) calculation. Generally, the Figure of Merit calculation may provide an estimation of a likelihood that a vehicle stop event will occur, e.g., within a predetermined time window. A higher FOM value as predicted by the controller 122 generally indicates a higher likelihood of a vehicle stop event. The vehicle stop probability FOM calculation is used by a vehicle stop event imminent determination 214 to indicate a vehicle stop event, e.g., by way of a flag set upon determination that the vehicle 100 is about to stop within a predetermined time threshold. As examples of inputs, the driver intent determination 206 may employ one or more inputs indicative of a driver intention to bring the vehicle 100 to a stop, e.g., a position of a brake pedal of the vehicle 100, a position of an accelerator pedal of the vehicle 100, and a deceleration time associated with a deceleration of the vehicle 100. In one example, the deceleration time is an elapsed time associated with a continuous deceleration of the vehicle 100. The vehicle speed trend determination 208 may use as inputs any aspects of the vehicle 100 that are generally indicative of a likelihood of the vehicle 100 coming to a stop. For example, a speed of the vehicle 100, a rate of change of the vehicle speed (i.e., acceleration), a rate of change of speed of the engine 102 (i.e., an acceleration of engine speed), and vehicle deceleration time may be used to determine the vehicle speed trend. The vehicle deceleration determination may use an input the vehicle deceleration time. In one example, the vehicle deceleration determination selectively adjusts the vehicle stop probability calculation between two separate models, with one model using a first variable set when a long deceleration condition is not present, and a second model using another variable set when a long deceleration condition is present.

The driver intent determination 206, vehicle speed trend determination 208, and vehicle deceleration determination 210 may be used as inputs to the vehicle stop probability FOM calculation 212 in any manner that is convenient. In one example, the driver intent determination 206 yields a FOM increment/decrement value based upon accelerator position and brake pedal position values. In this example, if the accelerator value goes beyond a calibratable/predetermined threshold (i.e., the accelerator pedal is clearly indicative of acceleration, i.e., the driver does not intend to stop the vehicle 100), the logic will override the vehicle stop probability function 212 and set an output (e.g., “vehicle stop imminent”) flag to false.

Continuing with the above example, the long deceleration determination 210 may take a deceleration time of the vehicle 100 (e.g., computed from a speed of the vehicle 100), and apply a multiplier to the vehicle stop probability calculation 212. For example, if the driver brakes after a long deceleration, the calculated probability of the vehicle stopping will be greater than what the same brake input may yield after only a short deceleration.

The vehicle speed trend determination 208 may generally calculate an increment/decrement value for the vehicle stop probability function 212 based on a current speed of the vehicle 100 and its derivative (i.e., acceleration/deceleration of the vehicle 100).

The vehicle stop probability function 212 may be determined from a lookup table based on vehicle speed and a derivative of the vehicle speed, with an additional axis for the derivative of the engine speed. A value determined by the vehicle stop probability function 212 may then be an addition of outputs of the driver intent determination 206, vehicle speed trend determination 208, and vehicle deceleration determination 210. At the vehicle stop event imminent judgement function 214, the value determined by the vehicle stop probability function 212 may be compared against a calibratable threshold to determine a final true/false output associated with whether a vehicle stop is imminent.

Each of the driver intent determination 206, vehicle speed trend determination 208, and vehicle deceleration determination 210 may be separate models associated with a history of the vehicle 100. In one example approach, each of these three inputs is sampled (e.g., at a 100-millisecond rate) with a prediction based upon a predetermined number of most recent samples (e.g., the last 4 samples of each input, resulting in a 0.4 millisecond memory). At the same time, the prediction of a vehicle stop event will abort or be overridden if speed of the vehicle 100 is above a threshold or if the user applies the accelerator pedal.

Continuing with the foregoing example, the driver intent determination 206, vehicle speed trend determination 208, and vehicle deceleration determination 210 may each be modeled based upon a previous history associated with the vehicle 100, e.g., a dynamometer emission cycle, real world driving data, or both, to create a correlation of the inputs I or any subsets thereof. In an example, vehicle speed modelled for a predetermined time period ahead of current time, e.g., 5 seconds ahead, with a Hammerstein-Wiener (HW) non-linear system. Weight factor(s) of each input and their effect on near-future vehicle speed may also be identified. In one example approach, a simplified model may be abstracted from the more complex HW model to reduce resource consumption, to the extent it may provide similar results. Moreover, the models of the driver intent determination 206, vehicle speed trend determination 208, and vehicle deceleration determination 210 may be adjusted based upon real-world driving history associated with vehicle 100, e.g., after a given owner has operated the vehicle 100 for a period of time sufficient to discern patterns of behavior with respect to vehicle stops.

Turning now to FIG. 2B, an alternative example of a vehicle stop predictor 200b is illustrated. The vehicle stop predictor 200b is based upon a nonlinear state-space Hammerstein-Wiener (HW) model, which may use any vehicle parameters that are convenient. The vehicle stop predictor 200b, in one example, uses as inputs the accelerator pedal and brake pedal positions, a speed of the vehicle 100, a derivative (i.e., acceleration) of the speed of the vehicle 100, and deceleration time of the vehicle 100. The model predicts actual speed of the vehicle 100 ahead of real-time by a predetermined time window, e.g., 5 seconds ahead, in contrast to the output flag approach used in connection with the vehicle stop predictor 200a of FIG. 2A described above.

In the example vehicle stop predictor 200b, a nonlinear transformation matrix 216 may provide an output to a linear transform function 218, which in turn provides an output to an output nonlinear function 220. In one such example of the vehicle stop predictor 200b, an input u(t) to the nonlinear transformation matrix 216 is an array made up of: [a relative measurement of accelerator pedal position to a brake pedal position (e.g., accelerator pedal position minus brake pedal position), vehicle speed, derivative of vehicle speed, derivative of engine speed, and a deceleration time]. The output of the input nonlinearity function 216 (and input to the linear transform function 218) may be represented by:

w(t)=f(u(t))

where f is a nonlinear transformation.

The output of the linear transformation function 218 may be represented by:

x(t)=B/F(w(t))

where B and F are linear transformation matrices.

The output of the nonlinear function 220 may be represented by y(t), which may in this example be a prediction of vehicle speed five (5.0) seconds in advance, which is acquired by applying a non-linear transformation h on x(t), with y(t)=h(x(t)). Respective weighting values f (for the nonlinear transformation matrix 216), B and F (for the linear transform function 218), and h (for the nonlinear function 200) for each of the matrices may be trained from a history associated with the vehicle 100, e.g., using emission dyno test data, real-world driving or development data for the vehicle 100, or the like. As noted above, the vehicle stop predictor 200b may predict actual vehicle speed of the vehicle 100 up to a predetermined window of time ahead of real-time, e.g., five (5.0) seconds in advance. In one such example, 10 delay states are used with a sampling frequency of 100 milliseconds samples, resulting in a memory span of 1 second. Continuing with this example, the vehicle stop predictor 200b may use the accelerator or brake pedal position, vehicle speed, derivative of vehicle speed, and deceleration time as inputs.

For each of the example vehicle stop predictors 200a and 200b, the vehicle 100 may generally forecast a vehicle stop while the vehicle 100 is still moving. When the vehicle stop predictors 200a or 200b determine that a vehicle stop event is about to occur (e.g., when the vehicle stop predictor 200a sets a “vehicle stop imminent” flag, or when the vehicle stop predictor 200b predicts a vehicle speed of zero within a given time window), the controller 122 may deactivate or reduce activity of the purge pump 112. Accordingly, noise or vibration emitted by the purge pump 112 is reduced or eliminated entirely, and is thus not detected by vehicle occupants as the vehicle 100 comes to a stop or reduces to near-zero speeds.

In addition to reducing activity of the purge pump 112, the evaporative emissions controller 202 and purge pump controller 204 (see FIG. 1B) may each be switched to an idle mode, resulting in the switching off of an associated purge valve 114 and switching of long term memory (LTM) cells. LTM or “fuel trim” may generally characterize long term injection fuel bias, e.g., as may be caused by imperfection or wear on fuel injectors, the air intake, etc. Fuel trim may in some examples be represented by two separate determinations, with one being relevant to situations where the purge pump 112 is “on,” with another used where the purge pump 112 is “off.” The two separate calculations may be distinguished by fuel trim correcting for injector and air intake bias when the pump is “off,” while additionally accounting for purge vapor where the purge pump 112 is “on.” Providing an indication of the purge pump 112 status to the fuel trim determination may prevent engine roughness and reduce incidence of stalling (e.g., as may result where purge vapor is not being supplied but the fuel trim calculation assumes it to be present, reducing fuel supplied to the fuel injector (not shown) and causing drivability issues and high nitrogen-oxide (NOx) emission. Accordingly, to the extent an indication of the purge pump 112 status is provided to the fuel trim determination, the incidence of engine roughness or stalling may be reduced.

### Method

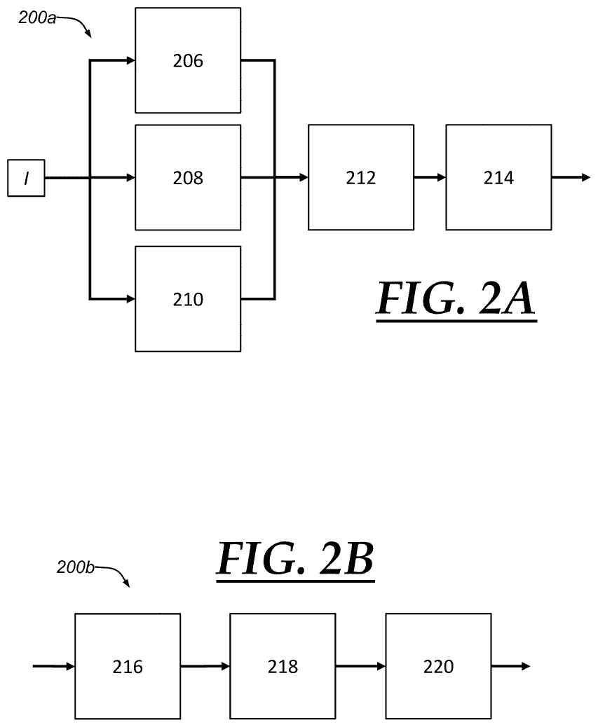

Turning now to FIG. 3, an example process flow diagram is illustrated for a process 300 of operating a purge pump for a vehicle. Process 300 may begin at block 305, where a fuel vapor canister is provided that is in fluid communication with a fuel tank of the vehicle. For example, as illustrated and discussed above in FIGS. 1A and 1B, a vehicle 100 may have a fuel vapor canister 110 that is configured to absorb fuel vapors from fuel tank 106. Process 300 may then proceed to block 310.

At block 310, a purge pump may be placed in fluid communication with the fuel vapor canister. For example, a purge pump 112 may be configured to pump an external airflow into the canister 110 from an ambient or external air source 150 from outside of the vehicle 100.

Proceeding to block 315, a vehicle stop may be predicted while the vehicle is moving based upon a model of vehicle speed. In some example approaches, e.g., as illustrated in FIG. 2A, a vehicle stop predictor 200a may determine a driver intention trend using a driver intention trend determination 206, and a vehicle speed trend using a vehicle speed trend determination 208. In other approaches, e.g., as illustrated in FIG. 2B, a vehicle stop predictor 200b may model vehicle speed directly.

In either of the foregoing example approaches, any vehicle parameter(s) may be used as inputs to be correlated with vehicle stop events. For example, as discussed above, a driver intention trend may be determined based upon at least one of (or all of, or a subset of) a brake pedal position, an accelerator pedal position, and a vehicle deceleration time. A vehicle speed trend may be determined using at least one of (or all of, or a subset of) a vehicle speed, a vehicle deceleration, and a rate of change of vehicle engine speed.

In some examples, e.g., as discussed above in connection with vehicle stop predictor 200a, vehicle stop events may be predicted based at least upon an extended deceleration state of the vehicle. Such a state of the vehicle 100 may be determined based upon at least a vehicle deceleration time.

The various example approaches may all generally correlate vehicle stop events, e.g., in a vehicle test cycle or previous driving history of the vehicle 100, with any of the example input(s). For example, vehicle stop events may be correlated with any one or more of a brake pedal position, an accelerator pedal position, and a vehicle deceleration time. The predicted vehicle stop may thus be based upon the correlation between the vehicle stop events and the at least one of the brake pedal position, the accelerator pedal position, and the vehicle deceleration time. Process 300 may then proceed to block 320.

At block 320, ambient noise associated with the purge pump may be reduced or eliminated before the vehicle 100 stops. For example, a purge pump 112 may be stopped entirely, or simply reduced in activity (e.g., by reducing pump speed/output). Process 300 may then terminate.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of operating a purge pump for a vehicle, comprising:
(a) providing a fuel vapor canister in fluid communication with a fuel tank of the vehicle, the fuel vapor canister configured to absorb fuel vapors from the fuel tank;
(b) placing a purge pump in fluid communication with the fuel vapor canister, the purge pump configured to pump an external airflow into the canister;
(c) predicting a vehicle stop while the vehicle is moving based upon at least a model of vehicle speed; and
(d) reducing ambient noise emitted by the purge pump based upon the prediction in step (c) before the vehicle stops moving.

2. The method of claim 1, wherein reducing ambient noise emitted by the purge pump includes stopping the purge pump.

3. The method of claim 1, wherein reducing ambient noise emitted by the purge pump includes reducing an activity of the purge pump.

4. The method of claim 1, wherein the step of predicting a vehicle stop includes predicting the vehicle stop based upon at least a vehicle speed trend and a driver intention trend.

5. The method of claim 4, further comprising determining the driver intention trend based upon at least one of a brake pedal position, an accelerator pedal position, and a vehicle deceleration time.

6. The method of claim 4, further comprising determining the driver intention trend based upon at least a brake pedal position, an accelerator pedal position, and a vehicle deceleration time.

7. The method of claim 4, further comprising determining the vehicle speed trend based upon at least one of a vehicle speed, a vehicle deceleration, and a rate of change of vehicle engine speed.

8. The method of claim 4, further comprising determining the vehicle speed trend based upon at least a vehicle speed, a vehicle deceleration, and a rate of change of vehicle engine speed.

9. The method of claim 1, further comprising determining an extended deceleration state of the vehicle based upon at least a vehicle deceleration time.

10. The method of claim 9, wherein the vehicle stop predicted in step (c) is based upon at least the determined extended deceleration state of the vehicle.

11. The method of claim 1, further comprising correlating vehicle stop events in a vehicle test cycle with at least one of a brake pedal position, an accelerator pedal position, and a vehicle deceleration time, wherein the predicted vehicle stop is based upon the correlation between the vehicle stop events and the at least one of the brake pedal position, the accelerator pedal position, and the vehicle deceleration time.

12. The method of claim 1, further comprising correlating vehicle stop events in a vehicle test cycle with at least a brake pedal position, an accelerator pedal position, a vehicle deceleration time, a vehicle speed, a rate of change of vehicle speed, and a rate of change of vehicle engine speed, wherein the predicted vehicle stop is based upon the correlation between the vehicle stop events and the brake pedal position, the accelerator pedal position, the vehicle deceleration time, the vehicle speed, the rate of change of vehicle speed, and the rate of change of vehicle engine speed.

13. A method of predicting a vehicle stop while the vehicle is moving, comprising:
(a) predicting an intended vehicle stop while the vehicle is moving based upon at least a model of vehicle speed; and
(b) initiating a vehicle response based upon the prediction in step (a) before the vehicle stops moving.

14. The method of claim 13, wherein predicting the vehicle stop includes at least:
(a1) determining a vehicle speed trend based upon at least one of a vehicle speed, a vehicle deceleration, and a rate of change of vehicle engine speed; and
(a2) determining a driver intention trend based upon at least one of a brake pedal position, an accelerator pedal position, and a vehicle deceleration time;

15. The method of claim 14, further comprising:
(c) providing a fuel vapor canister in fluid communication with a fuel tank of the vehicle, the fuel vapor canister configured to absorb fuel vapors from the fuel tank; and
(d) placing a purge pump in fluid communication with the fuel vapor canister, the purge pump configured to pump an external airflow into the canister;
wherein the vehicle response in step (c) includes reducing ambient noise emitted by the purge pump.

16. An evaporative emissions control system for a vehicle, comprising:
a fuel vapor canister configured to absorb fuel vapors from a fuel tank;
a purge pump configured to pump an external airflow into the canister; and
a processor configured to predict a vehicle stop while the vehicle is moving based upon a model of vehicle speed, the processor configured to reduce ambient noise emitted by the purge pump based upon the predicted vehicle stop before the vehicle stops moving.

17. The evaporative emissions control system of claim 16, wherein the processor is configured to reduce ambient noise emitted by the purge pump by stopping the purge pump.

18. The evaporative emissions control system of claim 16, wherein the processor is configured to reduce ambient noise emitted by the purge pump by reducing an activity of the purge pump.

19. The evaporative emissions control system of claim 16, wherein the processor is configured to determine a vehicle speed trend and a driver intention trend included in the modeled vehicle speed.

20. The evaporative emissions control system of claim 19, wherein the processor is configured to determine the driver intention trend based upon at least a brake pedal position, an accelerator pedal position, and a vehicle deceleration time, and the processor is configured to determine the vehicle speed trend based upon at least a vehicle speed, a vehicle deceleration, and a rate of change of vehicle engine speed.
